(19) United States
(12) Patent Application Publication
(10) Pub. No.: US 2026/0329472 A1
(43) Pub. Date: Oct. 22, 2026

(54) VIRTUAL SUPER BLOCK FOR SEQUENTIAL MEMORY OPERATIONS

(71) Applicant: Micron Technology, Inc., Boise, ID (US)

(72) Inventors: Kishore Kumar Muchherla, San Jose, CA (US); Eric N. Lee, San Jose, CA (US); Akira Goda, Meguro (JP); Jonathan Scott Parry, Boise, ID (US); Peter Sean Feeley, Boise, ID (US); Jeremy Binfet, Boise, ID (US)

(21) Appl. No.: 19/652,785

(22) Filed: Apr. 20, 2026

Related U.S. Application Data
(60) Provisional application No. 63/792,677, filed on Apr. 22, 2025.

(51) Int. Cl. G06F 3/06

(52) U.S. Cl. CPC G06F 3/0655; G06F 3/0604; G06F 3/064; G06F 3/0679

(57) ABSTRACT

A memory system can include a non-volatile memory device and a controller. The memory system can be used to perform concurrent read operations on a first block of a first super block and a second block of a second super block. The first block and the second block can comprise portions of a same plane of a memory die, and the first super block and the second super block can comprise a virtual super block. The concurrent read operations can be performed by the controller by simultaneously activating a first wordline of the first block and a second wordline of the second block. The concurrent read operations can be performed by the controller by sequentially staggering activation of a first bitline of the first block and a second bitline of the second block.

### PRIORITY APPLICATION

This application claims the benefit of priority to U.S. Provisional Application Serial Number 63/792,677, filed Apr. 22, 2025, which is incorporated herein by reference in its entirety.

### TECHNICAL FIELD

Embodiments of the disclosure relate generally to data read techniques for memory systems.

### BACKGROUND

A memory system can include one or more memory devices that store data. The memory devices can be, for example, non-volatile memory devices and volatile memory devices. In general, a host system can use a memory system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates generally an example of a computing system that includes a memory system in accordance with some embodiments of the present disclosure.

FIG. 2 illustrates generally an example of a die of a memory device arranged in planes and including memory blocks used for sequential read in accordance with some embodiments of the present disclosure.

FIG. 3 illustrates generally an example of a portion of a memory block including a plurality of memory cells with corresponding wordlines and bitlines.

FIG. 4 illustrates generally an example of a super block including a plurality of planes and dies.

FIG. 5 illustrates generally an example of a timing diagram showing wordline activation and bitline activation for sensing data.

FIG. 6 illustrates generally an example of a virtual super block in accordance with some embodiments of the present disclosure.

FIG. 7 illustrates generally an example that includes multiple super blocks in accordance with some embodiments of the present disclosure.

FIG. 8 illustrates generally an example of a first method for performing a read operation using a virtual super block in accordance with embodiments of the present disclosure.

FIG. 9 illustrates generally an example of a second method that can include writing information to a virtual super block in accordance with embodiments of the present disclosure.

FIG. 10 is a block diagram of an example of a computer system in which embodiments of the present disclosure may operate.

### DETAILED DESCRIPTION

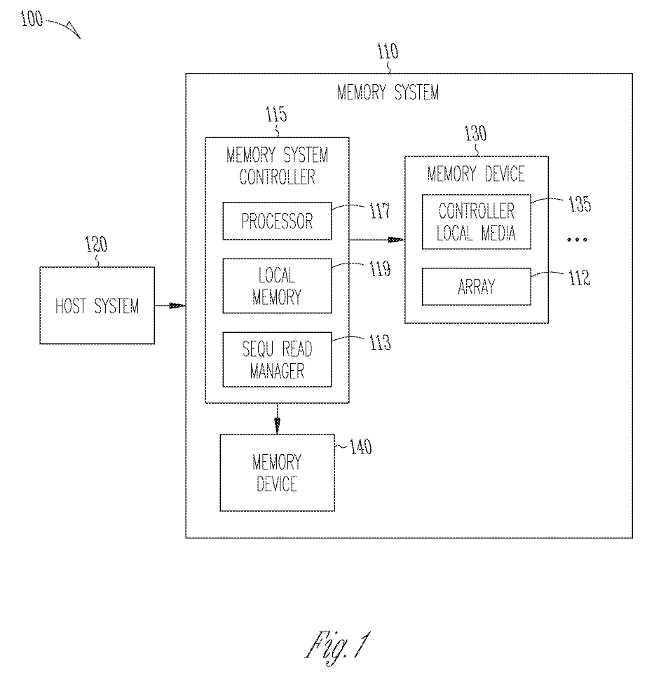

Aspects of the present disclosure are directed to a memory system for performing sequential reads in a memory system. A memory system can be a storage system, storage device, a memory module, or a combination of such. An example of a memory system is a storage system such as a solid-state drive (SSD). Examples of storage devices and memory modules are described below in conjunction with FIG. 1. In general, a host system can use a memory system that includes one or more components, such as memory devices that store data. The host system can provide data to be stored at the memory system and can request data to be retrieved from the memory system.

A memory device can be a non-volatile memory device. One example of a non-volatile memory device is a not-and (NAND) memory device (also known as a flash memory device). Other examples of non-volatile memory devices are described below. A non-volatile memory device generally includes a package of one or more dies or dice. Each die includes memory cells that are arranged in one or more planes. Planes can be grouped into logic units (LUN). For some types of non-volatile memory devices (e.g., NAND devices), each plane includes a set of physical blocks. Each block includes a set of pages, and each page includes a respective group of memory cells (“cells”). A cell is an electronic circuit that stores one or more bits of information. A block refers to a unit of the memory device used to store data and can include a group of memory cells, a wordline (equivalently, word line) group, or individual memory cells. In some memory devices, a block (also referred to as a “memory block”) of data can be erased as a unit, while data can be read from or written to individual pages.

A memory device can include one or more arrays of memory cells. Depending on the cell type, a cell can store one or more bits of binary information, and can have various logic states that correlate to the number of bits stored. The logic states can be represented by binary values, such as "0" and "1" or combinations of such values. There are various types of cells, such as single level cells (SLCs), multi-level cells (MLCs), triple level cells (TLCs), and quad-level cells (QLCs). For example, an SLC can store one bit of information corresponding to one of two logic states.

Some NAND memory devices use a floating-gate architecture in which memory accesses are controlled based on a relative voltage change between a bitline (equivalently, bit line) and the wordlines. Other examples of NAND memory devices can use a replacement-gate architecture that can include wordline layouts that can allow for charges corresponding to data values to be trapped within memory cells based on properties of the materials used to construct the wordlines.

The present inventors have recognized, among other things, that host bus speeds are increasing, leading to increased NAND read speeds to saturate the host bus. The inventors have further recognized that NAND read bandwidth is defined by factors such as plane parallelism, bytes per plane (page size), and read time (tR), and that concurrent read operations can be limited because blocks within the same plane share common page buffers and bitlines. The present inventors have recognized that a solution to these and other issues can include or use a “virtual super block” to help enhance read efficiency by allowing concurrent reads on multiple blocks within a plane, which in turn can help realize larger transfer sizes or larger queue depths. By enabling read concurrency across different blocks within the same plane, wordline overhead can be minimized. In an example, a virtual super block includes two or more super blocks that are paired and read together. The read operation can include staggered bitline activations and sense operations across blocks in the virtual super block.

In an example, an operation using a virtual super block can include performing concurrent read operations on a first block of a first super block and a second block of a second super block. The first block and the second block can be within a same plane and the first super block and the second super block can comprise the virtual super block. The concurrent read operations can be performed by simultaneously activating a first wordline of the first block and a second wordline of the second block and then sequentially staggering activation of a first bitline of the first block and a second bitline of the second block.

FIG. 1 illustrates an example computing system 100 that includes a memory system 110 in accordance with some embodiments of the present disclosure. The memory system 110 can include media, such as one or more volatile memory devices (e.g., memory device 140), one or more non-volatile memory devices (e.g., memory device 130), or a combination of such devices.

The memory system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, server, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory systems 110. In some embodiments, the host system 120 is coupled to multiple different types of the memory system 110. FIG. 1 illustrates one example of a host system 120 coupled to one memory system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor and software executed by the processor. The processor can include one or more cores, one or more caches, a memory controller (e.g., an SSD controller), and a storage protocol controller (e.g., PCIe controller, SATA controller, CXL controller, etc.). The host system 120 uses the memory system 110, for example, to write data to one or more memory devices.

The host system 120 can be coupled to the memory system 110 using a physical host interface. Examples of a physical host interface include, but are not limited to, a compute express link (CXL) interface, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory system 110. In an example, the host system 120 can use an NVM Express (NVMe) interface to access components (e.g., memory devices 130) when the memory system 110 is coupled with the host system 120 by the PCIe interface. The physical host interface can provide an interface for passing control, address, data, and other signals between the memory system 110 and the host system 120.

The memory devices 130, 140 can include any combination of the different types of non-volatile memory devices and/or volatile memory devices. The volatile memory devices (e.g., memory device 140) can be, but are not limited to, random access memory (RAM), such as dynamic random-access memory (DRAM) and synchronous dynamic random access memory (SDRAM).

Some examples of non-volatile memory devices (e.g., memory device 130) include flash memory and write-in-place memory, such as three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130, 140 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLC) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data.

In an example, each memory device can include a number of memory cells arranged in, for example, a number of devices, planes, blocks, physical pages, super blocks, or super pages. As one example, a TLC memory device can include 18,592 bytes (B) of data per page, 1536 pages per block, 548 blocks per plane, and 4 planes per device. As another example, an MLC memory device can include 18,592 bytes (B) of data per page, 1024 pages per block, 548 blocks per plane, and 4 planes per device, but with half the required write time and twice the program/erase (P/E) cycles as a corresponding TLC memory device. Other examples can include other numbers or arrangements. A super block can include a combination of multiple blocks, such as from different planes, etc., and a window can refer to a stripe of a super block, typically matching a portion covered by a physical-to-logical (P2L) table chunk, etc., and a super page can include a combination of multiple pages.

The term “super” can refer to a combination or multiples of a thing or things. For example, a super block can include a combination of blocks. If a memory device includes 4 planes, a super block may refer to the same block on each plane, or a pattern of blocks across the planes (e.g., a combination of block 0 on plane 0, block 1 on plane 1, block 2 on plane 2, and block 3 on plane 3, etc.). In an example, if a storage system includes multiple memory devices, the combination or pattern of blocks can extend across the multiple memory devices. The term “stripe” can refer to a pattern or combination of patterns. For example, a stripe of a super block can refer to a combination or pattern of pages from each block in the super block.

Although non-volatile memory components such as three-dimensional cross-point arrays of non-volatile memory cells and NAND type memory (e.g., 2D NAND, 3D NAND) are described, the memory device 130 can be based on any other type of non-volatile memory or storage device, such as such as, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, and electrically erasable programmable read-only memory (EEPROM).

The memory system controller 115 can communicate with the one or more memory devices 130 to perform operations such as reading data, writing data, or erasing data at the memory devices 130 and other such operations. The memory system controller 115 can include hardware such as one or more integrated circuits and/or discrete components, a buffer memory, or a combination thereof. The hardware can include digital circuitry with dedicated (i.e., hard-coded) logic to perform the operations described herein. The memory system controller 115 can be a microcontroller, special purpose logic circuitry (e.g., a field programmable gate array (FPGA), an application specific integrated circuit (ASIC), etc.), or other processor.

The memory system controller 115 can include a processor 117 (e.g., a processing device) configured to execute instructions stored in a local memory 119. In the illustrated example, the local memory 119 of the memory system controller 115 includes an embedded memory configured to store instructions for performing various processes, operations, logic flows, and routines that control operation of the memory system 110, including handling communications between the memory system 110 and the host system 120.

In some embodiments, the local memory 119 can include memory registers storing memory pointers, fetched data, etc. The local memory 119 can also include read-only memory (ROM) for storing micro-code. While the example memory system 110 in FIG. 1 has been illustrated as including the memory system controller 115, in another embodiment of the present disclosure, a memory system 110 does not include a memory system controller 115, and can instead rely upon external control (e.g., provided by an external host, or by a processor or controller separate from the memory system).

In general, the memory system controller 115 can receive commands or operations from the host system 120 and can convert the commands or operations into instructions or appropriate commands to achieve the desired access to the memory device 130 and/or the memory device 140. The memory system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address, physical media locations, etc.) that are associated with the memory devices 130. As an example, an LBA can refer to a linear addressing scheme that specifies the locations of data blocks in storage devices to find these data blocks or specified portions of data. The term can refer to both the address and the block to which it refers. The memory system controller 115 can further include host interface circuitry to communicate with the host system 120 via the physical host interface. The host interface circuitry can convert the commands received from the host system into command instructions to access the memory device 130 and/or the memory device 140 as well as convert responses associated with the memory device 130 and/or the memory device 140 into information for the host system 120.

The memory system 110 can include other circuitry or components that are not illustrated. In some embodiments, the memory system 110 can include a cache or buffer (e.g., DRAM) and address circuitry (e.g., a row decoder and a column decoder) that can receive an address from the memory system controller 115 and decode the address to access the memory device 130 and/or the memory device 140.

In some embodiments, the memory device 130 includes a local media controller 135 that operates in conjunction with memory system controller 115 to execute operations on one or more memory cells of the memory devices 130. An external controller (e.g., memory system controller 115) can externally manage the memory device 130 (e.g., perform media management operations on the memory device 130). In some embodiments, the memory device 130 is a managed memory device, which is a raw memory device combined with a local controller (e.g., the local media controller 135) for media management within the same memory device package. An example of a managed memory device is a managed NAND (mNAND) device.

The memory system 110 can include a sequential read (“SEQU READ”) manager 113. Although not shown in FIG. 1, the sequential read manager 113 can include circuitry configured to facilitate read operations for a memory system and/or components of the memory system. In an example, the sequential read manager 113 can be configured to determine when or whether to activate a particular wordline, bitline, or sense amplifier to read data in a particular sequence or order to adjust read and/or write times. In some embodiments, the sequential read manager 113 can include special purpose circuitry in the form of an ASIC, FPGA, state machine, and/or other logic circuitry that can allow the sequential read manager 113 to orchestrate and/or perform operations to selectively perform sequential read operations for the memory device 130 and/or the memory device 140 based on host preferences and/or sequential read parameters.

In some embodiments, the memory system controller 115 includes at least a portion of the sequential read manager 113. For example, the memory system controller 115 can include a processor 117 (processing device) configured to execute instructions stored in local memory 119 for performing the operations described herein. In some embodiments, the sequential read manager 113 is part of the host system 120, an application, or an operating system.

In a non-limiting example, an apparatus (e.g., the computing system 100) can include the memory system sequential read manager 113, and the memory system sequential read manager 113 can be resident on the memory system 110. As used herein, the term “resident on” refers to something that is physically located on a particular component. For example, the memory system sequential read manager 113 being “resident on” the memory system 110 refers to a condition in which the hardware circuitry that comprises the memory system sequential read manager 113 is physically located on the memory system 110. The term “resident on” can be used interchangeably with other terms such as “deployed on” or “located on,” herein. The memory system sequential read manager 113 can be configured to perform, or cause to be performed, operations on memory cells of an array 112 of the memory device 130.

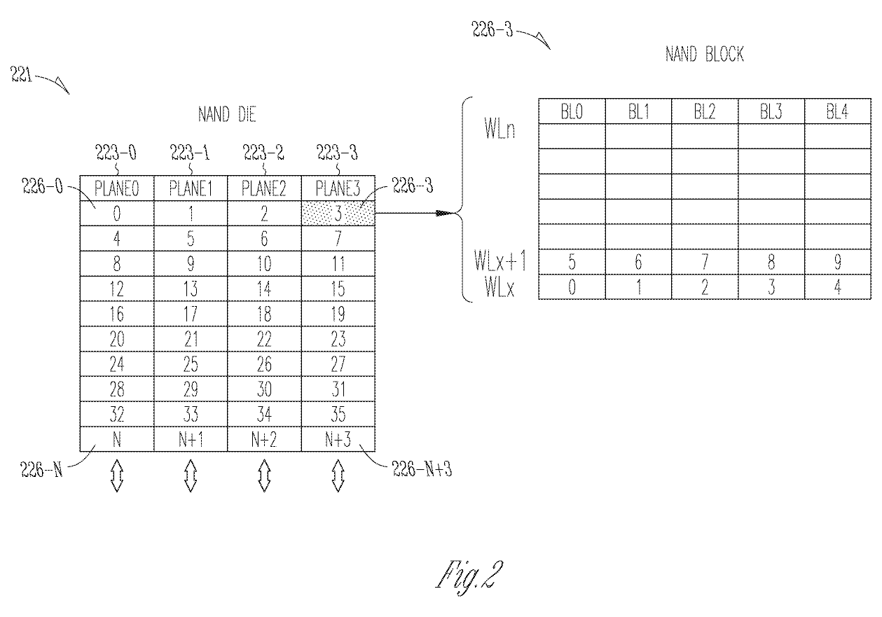

FIG. 2 illustrates an example of a die 221 of a memory device arranged in planes 223 including respective memory blocks 226 that can be used for sequential read in memory in accordance with some embodiments of the present disclosure. For example, the die 221 can include, in a zeroth plane (“Plane 0”) 223-0, multiple blocks including a zero-th memory block (“0”) 226-0 through an Nth memory block (“N”) 226-N. The die 221 can include, in a first plane (“Plane1”) 223-1, multiple blocks including a first block (“1”) through an N+1^{st} memory block (“N+1”), and so on across each of the illustrated planes. The third plane (“Plane3”) 223-3 can extend from a third memory block (“3”) 226-3 to an N+3 memory block (“N+3”) 226-N+3. In this way, memory blocks “0” 226-0 through “N+3” 226-N+3 can be arranged in each of a number of planes (illustrated as four planes but not so limited in other examples).

FIG. 2 illustrates an example of a hierarchical organization of a NAND memory device. The figure shows the NAND storage area, or array, divided into multiple organizational units. At left, the NAND array is shown partitioned into the planes 223-0 to 223-3 (referred to collectively as planes 223). In an example, the planes 223 can be used in parallel data operations, where multiple read and write operations can be executed simultaneously across different planes, facilitating enhanced data throughput.

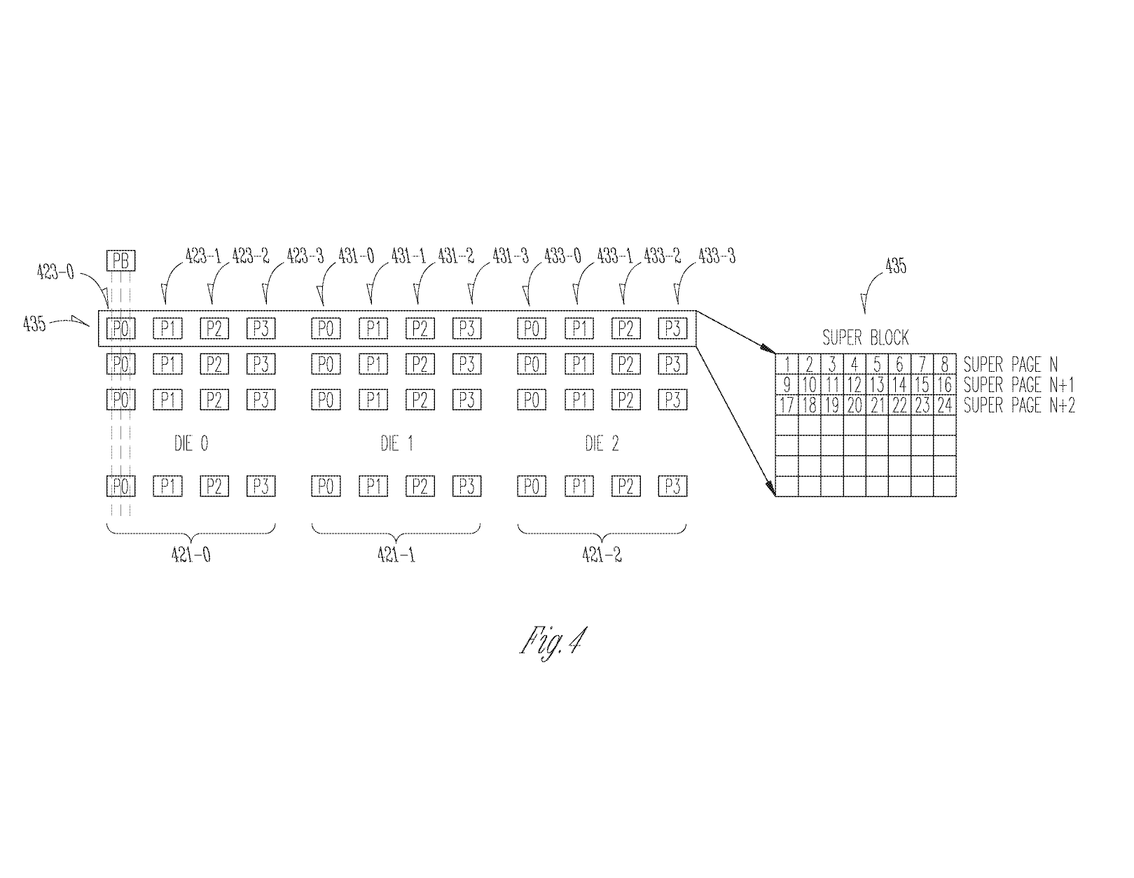

In the example of FIG. 2, each plane can be divided into memory blocks 226, which can be physical or virtual blocks. Each of the blocks 226 corresponds to a respective group of wordlines WLx to WLn with selector elements positioned at their upper and bottom boundaries, as described in FIG. 4 below. Each of the wordlines corresponds to multiple pages. In this hierarchical organization, a data indexing structure is provided with each of the blocks 226 containing multiple pages, typically configured with fixed-size allocations. Common block sizes include 4KB, 8KB, or 16KB, though implementations may vary. Pages, functioning as smaller storage units within blocks, contain the actual data records and enable granular data access. The example of the block 226-3 includes n+1 pages, with each page corresponding to a respective wordline. Particular cells of each page can be accessed using respective bitlines BL0 through BL4.

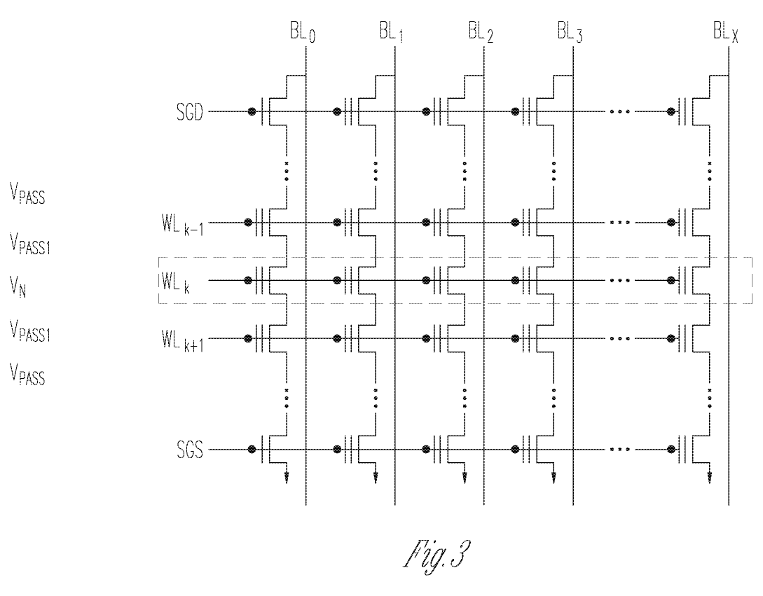

FIG. 3 illustrates generally an example of a portion of a memory block including a plurality of wordlines and bitlines used to access various memory cells. The example includes three particular wordlines, WLₖ, WLₖ₊₁, and WLₖ₋₁ and four bitlines BL₀ through BL_{X}. The example shows multiple memory pages (e.g., comprising user data and metadata), with each page corresponding to a particular wordline. The illustrated block shows a Select Gate Drain (SGD) line that connects each bitline to its respective page buffer, and a Select Gate Source (SGS) line. Turning on a particular SGD and SGS pair activates the corresponding string so that charge information can be read from the bitline.

In a read operation, an SGD and SGS pair corresponding to a particular bitline can be turned on. The resulting string current, which varies based on the voltage (Vt) of each cell in the string, influences the bitline state. This state information can be detected by sense amplifiers in the page buffer. To read the voltage of a selected cell on a specific wordline (e.g., WLₖ), unselected cells in the string are made electrically transparent by applying a pass voltage, V_{PASS}, to wordlines that correspond to the unselected cells. Inherent RC characteristics of the circuit influence the time required to charge the wordlines to the pass voltage. Such charge time can limit or affect memory device performance.

FIG. 4 illustrates an example of a super block 435 that corresponds to a plurality of dies 421. Each of the dies includes a plurality of planes. For example, a first die 421-0 includes first through fourth planes 423-0 to 423-3 (referred to collectively as planes 423); a second die 421-1 includes planes 431-0 to 431-3 (referred to collectively as planes 431); and a third die 421-2 includes planes 433-0 to 433-3 (referred to collectively as planes 433). FIG. 4 illustrates a relationship between the dies 421, planes 423, 431, 433, blocks (e.g., as illustrated in FIG. 2 above), and a super block 435.

All of the blocks within a particular plane of a particular die can share a common page buffer (PB) and bitlines. For example, each of the blocks in plane P0 in the first die 421-0 can share a common page buffer, and each of the blocks in plane P1 in the first die 421-0 can share a separate common page buffer, and so on.

Blocks from multiple planes and dies can be grouped together to form a super block. For example, respective blocks from each of the planes 423, 431, 433 can be combined to form the super block 435. Each super block can have a capacity of, for example, one or more gigabytes. The super block structure can use sequential data writing operations, for example, to populate super pages using super page stripes. Each super page includes data from multiple pages, and those pages can comprise data from one or more planes of multiple dies.

In an example, the super block 435 comprises a first super page N, a second super page N+1, and a third super page N+2. A data writing process can include, for example, picking a block from each plane and die to form a stripe. Write and read operations can be parallelized across the blocks from each plane and die. However, because multiple blocks on the same plane share the same bitlines and page buffers, only one block is selected for a read operation at any given time. In an example, a virtual super block structure can be provided to help enable concurrent reads on multiple blocks on the same plane and thereby improve read bandwidth.

The present inventors have recognized that a problem to be solved includes improving sequential read bandwidth in memory devices where read operations involve multiple time-consuming steps. For example, each read operation includes charging a wordline, charging a bitline, and then performing sensing operations. While bitline charging and page buffer sensing are common resources shared by blocks within a plane, the wordline of each block is separately charged as reads switch from one block to another block. This separate charging of multiple wordlines creates an overhead that limits read performance, particularly as host bus speeds increase and require larger NAND read speeds to saturate the host bus.

The present inventors have recognized that a solution to these and other problems can include or use read concurrency across different blocks within the same plane to minimize wordline charging overhead. The solution can include staggering bitline activation and sense operations across blocks to mitigate the average wordline charging overhead per read time. In an example, the solution includes a change to the system data write path that includes pairing super blocks together to form virtual super blocks, with super pages written in a ping-pong fashion between the two super blocks. This enables concurrent reads on super blocks with multiple blocks simultaneously accessed within a plane at larger transfer sizes and/or larger queue depths, while using the same page address on different blocks within a plane. In an example, the solution includes pairing logically consecutive super blocks, which overcomes decoder complexity challenges that would otherwise arise when selecting two random blocks for simultaneous enablement.

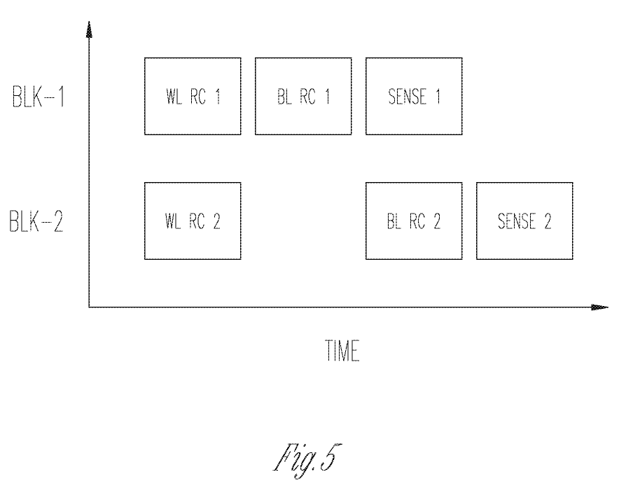

FIG. 5 is an example of a timing diagram showing wordline activation and bitline activation for sensing data using multiple blocks, such as can be used to perform sequential read in memory in accordance with some embodiments of the present disclosure. The example shows several stages of a read operation for a first block BLK-1 over time, including wordline charging (WL RC 1) followed by bitline charging (BL RC 1), and further followed by a first sense operation (SENSE 1). The example includes several stages of a read operation for a second block BLK-2 over time, including wordline charging (WL RC 2) followed by bitline charging (BL RC 2), and further followed by a second sense operation (SENSE 2). In the example of FIG. 5, the wordline charging operations can be performed concurrently for each of the first and second blocks, and the bitline charging operation for the second block (BL RC 2) can be performed concurrently with the first sense operation (SENSE 1). The example shows how concurrent wordline activations can be used, together with staggered bitline activations and sense operations, to help mitigate overhead per read operation (tR).

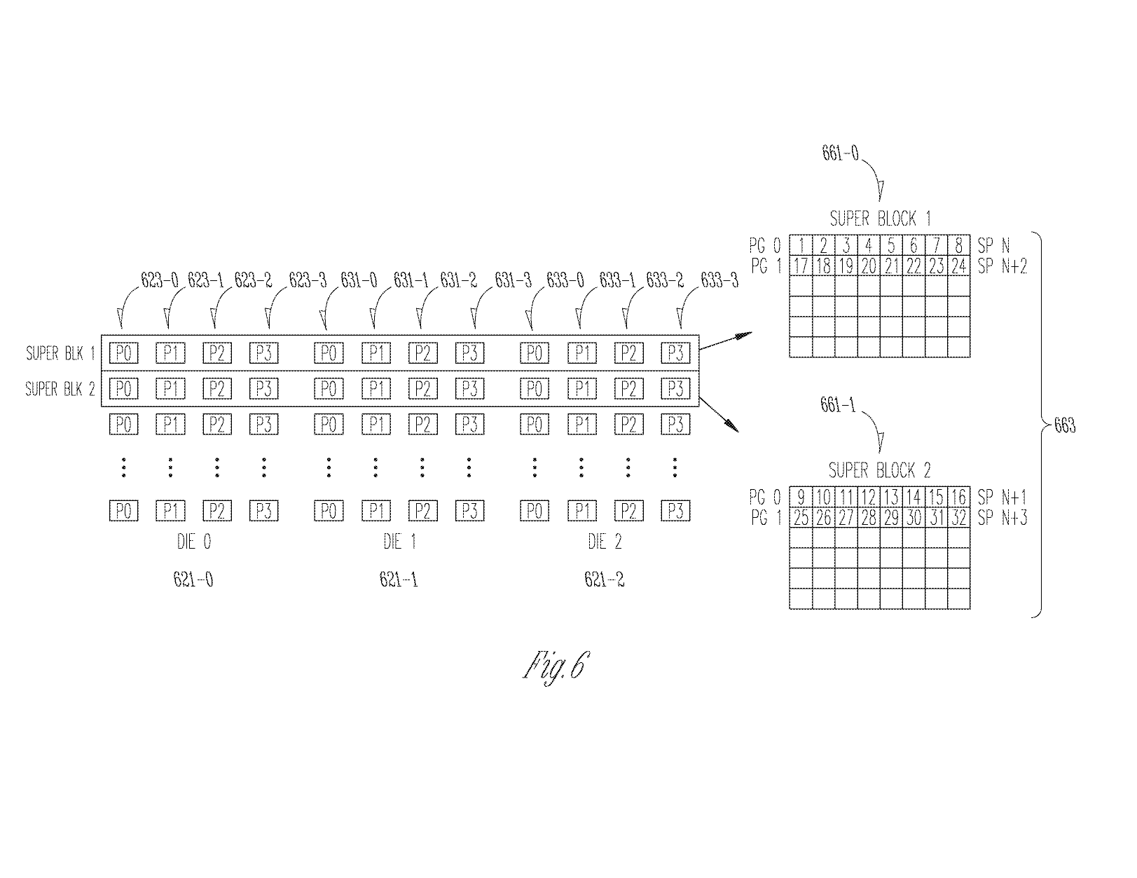

FIG. 6 illustrates generally an example of a virtual super block 663 of a memory device in accordance with embodiments of the present disclosure. In an example, the virtual super block can be used to help improve read concurrency in a memory system. The example of FIG. 6 shows, for example, a pair of super blocks that comprise the virtual super block 663, such as a first super block 661-0 and a second super block 661-1.

The first and second super blocks 661-0 and 661-1 correspond to a plurality of dies 621. Each of the dies includes a plurality of planes. For example, a first die 621-0 includes first through fourth planes 623-0 to 623-3 (referred to collectively as planes 623); a second die 621-1 includes planes 631-0 to 631-3 (referred to collectively as planes 631); and a third die 621-2 includes planes 633-0 to 633-3 (referred to collectively as planes 633). FIG. 6 illustrates a relationship between the dies 621, planes 623, 631, 633, the super blocks 661, and the virtual super block 663.

The virtual super block 663 can be formed in a ping-pong manner using information from, for example, two different super blocks such as the first super block 661-0 and the second super block 661-1. Each of the super blocks 661 can comprise information from a respective block portion of a memory device. That is, the memory device can comprise multiple block portions that can be spread across multiple planes and/or dies. Pages of the different block portions can be used to populate the super blocks 661.

In an example, the first super block 661-0 comprises blocks from a first page (PG 0) and a second page (PG 1). The first page PG 0 of the first super block 661-0 can be a first super page (SP N) of the virtual super block 663, and can comprise one or more pages from one or more of the blocks, planes, or dies of a memory device. In the example of FIG. 6, portions of the first and second super blocks 661-0 and 661-1 are labeled with numbers 1 through 32. These numbers represent individual pages that together form various pages of the super blocks based on information from, for example, each plane and logic unit (LUN) (623-0 to 623-3, 631-0 to 631-3, 633-0 to 633-3). In an example, page “1” of the first super page SP N can comprise first information from a first block portion of the memory device (e.g., Page 0 of plane 623-0 (P0)). Page “2” of the first super page SP N can comprise second information from the first block portion of the memory device (e.g., Page 0 of plane 623-1), and so on to fill or stripe the first super page SP N. The illustrated numbers 1-32 can represent an order in which each portion of a super page is written. In an example, a host can write to logical addresses 1-32 that respectively correspond to the pages 1-32 shown in FIG. 6. In the example of FIG. 6, instead of using PG 1 of the first super block 661-0 to store the second super page SP N+1 (as shown, for example, in FIG. 4), the second super page SP N+1 can be stored using PG 0 of the second super block 661-1.

The second page PG 1 of the first super block 661-0 can be a third super page (SP N+2) of the virtual super block 663. For example, page “17” of the third super page SP N+2 can comprise third information from the first block portion of the memory device, and page “18” of the third super page SP N+2 can comprise fourth information from the first block portion of the memory device, and so on to fill or stripe the third super page SP N+2.

In an example, the second super block 661-1 comprises a first page (PG 0) and a second page (PG 1). The first page PG 0 of the second super block 661-1 can be a second super page (SP N+1) of the virtual super block 663. In an example, page “9” of the second super page SP N+1 can comprise first information from a second block portion of the memory device, and page “10” of the second super page SP N+1 can comprise second information from the second block portion of the memory device, and so on to fill or stripe the second super page SP N+1. The second page PG 1 of the second super block 661-1 can be a fourth super page (SP N+3) of the virtual super block 663. For example, page “25” of the fourth super page SP N+3 can comprise third information from the second block portion of the memory device, and page “26” of the fourth super page SP N+3 can comprise fourth information from the second block portion of the memory device, and so on to fill or stripe the fourth super page SP N+3.

In an example, a logically conjugate block refers to a pair of blocks within a plane that are logically consecutive or adjacent in their addressing and are paired together to form part of a virtual super block. These blocks can be selected to enable simplified implementation of concurrent reads within the same plane. For example, when constructing the virtual super block 663, logically conjugate block pairs within a plane (e.g., within the first plane P0) can be picked across all dies (e.g., across the dies 621). This pairing of consecutive blocks helps avoid decoder complexity that would otherwise be used when selecting two random blocks for simultaneous enablement. In other words, using logically conjugate blocks can be helpful because it enables the system to perform concurrent reads on multiple blocks simultaneously within a plane.

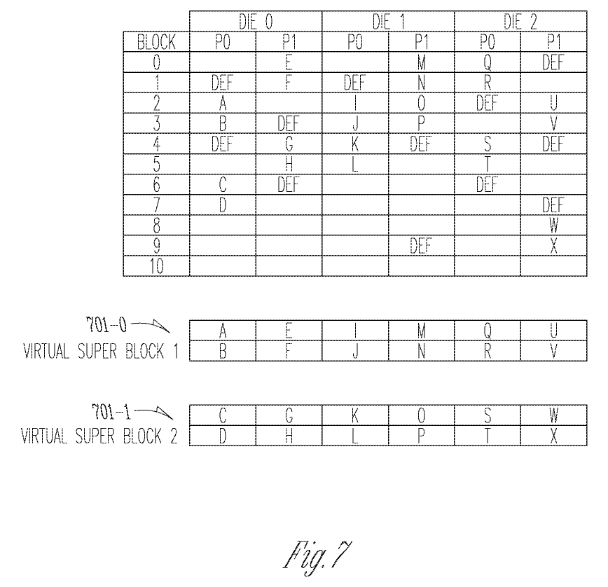

FIG. 7 illustrates generally an example that includes multiple virtual super blocks formed using block pairs, in accordance with embodiments of the present disclosure. The example shows that virtual super blocks can be selectively assembled using conjugate blocks from each of multiple planes and dies. In an example, a priority-based approach can be used to construct virtual super blocks, particularly in examples where defective blocks remain unrepaired, or examples where virtual super blocks occupy only a portion of a total device capacity, such as in fast read partition.

FIG. 7 includes a table that shows how particular blocks, from respective planes and dies of a memory device, can be used together to form multiple virtual super blocks. The example of FIG. 7 includes a first virtual super block 701-0 and a second virtual super block 701-1. The first and second virtual super blocks 701-0 and 701-1 can be populated using information from respective blocks of multiple dies, such as a first die (“die 0”), a second die (“die 1”) and a third die (“die 2”). In an example, one or more blocks of the dies can be unused or defective (labeled “DEF” in FIG. 7). Such unused blocks can be excluded from use in a virtual super block. In an example, unused blocks and their conjugates can be excluded from use in a virtual super block.

The particular blocks assigned to the first and second virtual super blocks 701-0 and 701-1 can be selected in an ordered manner. For example, a first known-good block pair can be selected for use in the first virtual super block 701-0 from each consecutive plane of each die. A second known-good block pair can be selected for use in the second virtual super block 701-1 from the consecutive planes of each die. An example follows.

In the example of FIG. 7, and beginning with plane 0 (P0) of die 0, block 1 is unused (DEF). Therefore, the block pair that comprises block 1 of P0, die 0, can be unused in a virtual super block. That is, the block pair of blocks 0 and 1 of P0, die 0, is unused in the virtual super blocks of FIG. 7. Block 2 of P0, die 0 is known-good and is labeled block “A” and block 3 of P0, die 0 is known-good and is labeled block “B.” Blocks A and B can be used together to form a first portion of the first virtual super block 701-0. Continuing consecutively with plane 1 (P1) of die 0, block 0 is known-good and is labeled block “E” and block 1 is known-good and is labeled block “F.” Blocks E and F can be used together to form a second portion of the first virtual super block 701-0. Subsequent or further portions of the first virtual super block can be selected in a similar manner by consecutively identifying known-good block pairs from consecutive planes or dies of the device.

Portions of the second virtual super block 701-1 can be similarly selected. For example, beginning with plane 0 (P0) of die 0, block 4 is the next available block, however, it is known to be unused (DEF). Therefore, the block pair that comprises block 4 of P0, die 0, can be unused in a virtual super block. That is, the block pair of blocks 4 and 5 of P0, die 0, is unused in the virtual super blocks of FIG. 7. Block 6 of P0, die 0 (block “C”) is the next known-good block, and its block pair (block 7 of P0, die 0, labeled block “D”) is also known-good. Blocks C and D can be used together to form a first portion of the second virtual super block 701-1. Continuing consecutively with plane 1 (P1) of die 0, the next known-good block pair includes blocks G and H. Accordingly, blocks G and H can be used together to form a second portion of the second virtual super block 701-1. Subsequent or further portions of the second virtual super block can be selected in a similar manner. Other block selection processes, which may or may not rely on consecutive blocks, can be similarly used to select blocks for use in one or more of the virtual super blocks.

In an example, a memory device includes a decoder for selecting blocks within planes for read operations. A virtual super block can be used to help improve decoder efficiency using a block addressing scheme that uses logically conjugate (adjacent) block pairs within each plane, such as shown in the example of FIG. 7. By using blocks with consecutive logical addresses to form the virtual super block, the system can enable concurrent access to multiple blocks within a plane using an address manipulation technique that includes, for example, masking the least significant bit of the block address. This approach provides advantages over decoders that would use other circuitry to simultaneously select two arbitrary blocks. The masking operation allows the system to efficiently identify and access the paired blocks using minimal additional hardware. When combined with the ping-pong writing scheme between super blocks, this addressing technique ensures data remains sequential across the logically adjacent blocks while using the same page address, thereby enabling more efficient concurrent reads without complex decoder circuitry.

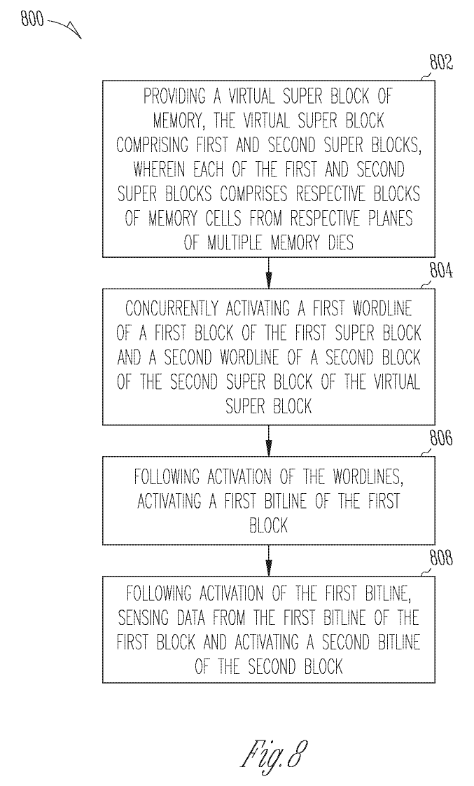

FIG. 8 illustrates generally an example of a first method 800 for performing a read operation using a virtual super block in accordance with embodiments of the present disclosure. The first method 800 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, first method 800 is performed by the controller 115 in coordination with the sequential read manager 113 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 802, the first method 800 includes providing a virtual super block structure comprising first and second super blocks. Each super block can include blocks of memory cells that are organized across planes of one or multiple memory dies.

At operation 804, the first method 800 includes concurrently activating wordlines of multiple different blocks. For example, operation 804 can include activating a first wordline in a first block of the first super block at substantially the same time as activating a second wordline in a second block of the second super block. Following activation of the wordlines at operation 804, the first method 800 can include sequentially staggering activation of bitlines and corresponding data sense or read operations.

At operation 806, the first method 800 includes activating a first bitline of the first block of the first super block. At operation 808, following activation of the first bitline at operation 806, the first method 800 includes sensing data from the first bitline of the first block. In an example, operation 808 can further include activating a bitline of the second block of the second super block. In an example, sensing the data from the first bitline and activating the bitline for the second block can be performed substantially concurrently. This staggered approach to bitline activation and sensing operations enables efficient use of shared resources while maintaining concurrent read capabilities. For example, the sequential staggering of bitline activation and sensing operations helps mitigate wordline RC overhead during read operations.

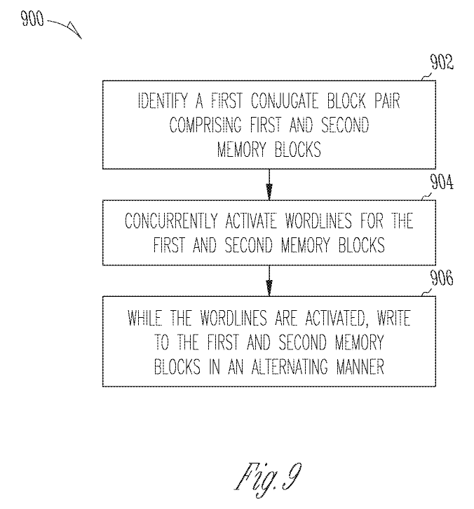

FIG. 9 illustrates generally an example of a second method 900 that can include writing information to a virtual super block in accordance with embodiments of the present disclosure. The method can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, method is performed by the controller 115 in coordination with the sequential read manager 113 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

The second method can include writing information to a virtual super block comprising a first super block and a second super block. The first super block and the second super block can each include memory blocks from multiple planes of a memory device. In an example, at operation 902, the second method 900 includes identifying a first conjugate block pair from a particular plane of a particular die of the memory device. The first conjugate block pair can include a first memory block and a second memory block that is logically adjacent to the first memory block.

At operation 904, the second method 900 can include concurrently activating a wordline for the first and second memory blocks of the first conjugate block pair. At operation 906, the second method 900 can include writing a first portion of the information to the first memory block and subsequently writing a second portion of the information to the second memory block. In an example, operation 906 can be performed while the wordlines are activated for the first and second memory blocks. In an example, writing the information at operation 906 can include writing first super pages to the first memory block and writing second super pages to the second memory block in an alternating manner.

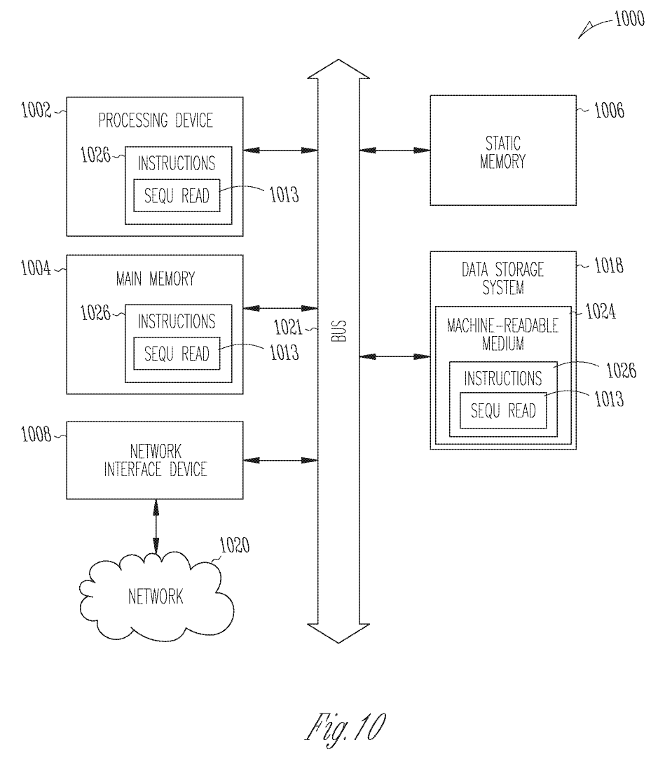

FIG. 10 is a block diagram of an example computer system 1000 in which embodiments of the present disclosure may operate. For example, FIG. 10 illustrates an example machine of a computer system 1000 within which a set of instructions, for causing the machine to perform any one or more of the methodologies discussed herein, can be executed. In some embodiments, the computer system 1000 can correspond to a host system (e.g., the host system 120 of FIG. 1) that includes, is coupled to, or utilizes a memory system (e.g., the memory system 110 of FIG. 1) or can be used to perform the operations of a controller (e.g., to execute an operating system to perform operations corresponding to the sequential read manager 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1000 includes a processing device 1002, a main memory 1004 (e.g., read-only memory (ROM), flash memory, dynamic random access memory (DRAM) such as synchronous DRAM (SDRAM) or Rambus DRAM (RDRAM), etc.), a static memory 1006 (e.g., flash memory, static random access memory (SRAM), etc.), and a data storage system 1018, which communicate with each other via a bus 1021.

The processing device 1002 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 1002 can also be one or more special-purpose processing devices such as an application specific integrated circuit (ASIC), a field programmable gate array (FPGA), a digital signal processor (DSP), network processor, or the like. The processing device 1002 is configured to execute instructions 1026 for performing the operations and steps discussed herein. The computer system 1000 can further include a network interface device 1008 to communicate over the network 1020.

The data storage system 1018 can include a machine-readable storage medium 1024 (also known as a computer-readable medium) on which is stored one or more sets of instructions 1026 or software embodying any one or more of the methodologies or functions described herein. The instructions 1026 can also reside, completely or at least partially, within the main memory 1004 and/or within the processing device 1002 during execution thereof by the computer system 1000, the main memory 1004 and the processing device 1002 also constituting machine-readable storage media. The machine-readable storage medium 1024, data storage system 1018, and/or main memory 1004 can correspond to the memory system 101 of FIG. 1.

In one embodiment, the instructions 1026 include instructions to implement functionality corresponding to a sequential read manager (e.g., the sequential read manager 113 of FIG. 1). While the machine-readable storage medium 1024 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

The following examples provide a non-limiting overview of, among other things, the sequential read systems and methods discussed herein.

Example 1 is a memory system comprising: a non-volatile memory device including a plurality of memory blocks, wherein each of the memory blocks comprises a portion of a plane of a die of the memory device; and a controller configured to: concurrently activate a first wordline of a first block of the memory blocks and a second wordline of a second block of the memory blocks, wherein the first and second blocks correspond to a same plane of the memory device; and following activation of the first and second wordlines, sequentially stagger activation of a first bitline corresponding to the first block and activation of a second bitline corresponding to the second block.

In Example 2, the subject matter of Example 1 optionally includes the controller is configured to sense data from the first block concurrently with activation of the second bitline.

In Example 3, the subject matter of Example 2 optionally includes the controller is configured to sense data from the second block subsequent to sensing the data from the first block.

In Example 4, the subject matter of any one or more of Examples 1–3 optionally includes the controller is configured to write super pages in a ping-pong manner between first and second super blocks to form a virtual super block, wherein the first and second blocks are included in the first and second super blocks, respectively.

In Example 5, the subject matter of any one or more of Examples 1–4 optionally includes the first and second blocks comprise logically conjugate block pairs within the same plane.

In Example 6, the subject matter of Example 5 optionally includes the controller is configured to select the logically conjugate block pairs by masking a least significant bit of corresponding block addresses.

In Example 7, the subject matter of any one or more of Examples 1–6 optionally includes the controller is configured to: sense data from the first block while activating the second bitline; and sense data from the second block after completing sensing of the data from the first block.

In Example 8, the subject matter of any one or more of Examples 1–7 optionally includes the controller is configured to: construct virtual super blocks by selecting logically consecutive super blocks, wherein the first and second blocks are included in different super blocks of a virtual super block, and the virtual super block is confined to a high read bandwidth partition of the memory device.

Example 9 is a method, comprising: providing a virtual super block of memory, the virtual super block comprising first and second super blocks, wherein each of the first and second super blocks comprises respective blocks of memory cells from respective planes of multiple memory dies; concurrently activating a first wordline of a first block of the first super block and a second wordline of a second block of the second super block of the virtual super block; following activation of the wordlines, activating a first bitline of the first block; and following activation of the first bitline, sensing data from the first bitline of the first block and activating a second bitline of the second block.

In Example 10, the subject matter of Example 9 optionally includes writing data in an alternating manner between super pages of the first and second super blocks of the virtual super block.

In Example 11, the subject matter of any one or more of Examples 9–10 optionally includes providing the virtual super block including using the first and second super blocks with logically conjugate block addresses.

In Example 12, the subject matter of any one or more of Examples 9–11 optionally includes the activation of the second bitline occurs concurrently with the sensing data from the first bitline.

In Example 13, the subject matter of Example 12 optionally includes the sensing of the data in the first block and the data in the second block includes using a same page buffer in line with both the first block and the second block.

In Example 14, the subject matter of any one or more of Examples 9–13 optionally includes the first block and the second block comprise portions of a same plane of the virtual super block.

In Example 15, the subject matter of any one or more of Examples 9–14 optionally includes selecting the first block and the second block based on the first and second blocks being in a same logical position of the respective first super block and the respective second super block.

In Example 16, the subject matter of any one or more of Examples 9–15 optionally includes writing super pages in a ping-pong manner between the first and second super blocks of the virtual super block, wherein the ping-pong writing enables concurrent reads on the first and second super blocks using the same page address within a particular plane.

In Example 17, the subject matter of any one or more of Examples 9–16 optionally includes selecting the first block and the second block such that the first block and the second block are accessed using a same page address.

Example 18 is a memory system comprising: a non-volatile memory device including a plurality of memory blocks; and a controller configured to: write information to a virtual super block comprising a first super block and a second super block, wherein the first super block and the second super block each include, memory blocks from multiple planes of the non-volatile memory device, wherein writing the information includes: identifying a first conjugate block pair from a particular plane of a particular die of the memory device, the first conjugate block pair including a first memory block and a second memory block that is logically adjacent to the first memory block; concurrently activating a wordline for the first and second memory blocks of the first conjugate block pair; and while the wordlines are activated for the first and second memory blocks, writing a first portion of the information to the first memory block and subsequently writing a second portion of the information to the second memory block.

In Example 19, the subject matter of Example 18 optionally includes writing the information including: writing first super pages to the first memory block of the first super block; and writing second super pages to the second memory block of the second super block in an alternating manner with the writing of the first super pages.

In Example 20, the subject matter of Example 19 optionally includes the controller configured to access data from the first and second super blocks using a same page address.

Each of these non-limiting examples or embodiments can stand on its own or can be combined in various permutations or combinations with one or more of the other examples or embodiments discussed herein.

This detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. The present inventors contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.”

In the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following statements (aspects) are hereby incorporated into the Detailed Description as examples or embodiments, with each standing on its own as a separate embodiment, and it is contemplated that such embodiments can be combined with each other in various combinations or permutations.

What is claimed is:

1. A memory system comprising:
a non-volatile memory device including a plurality of memory blocks, wherein each of the memory blocks comprises a portion of a plane of a die of the memory device; and
a controller configured to:
concurrently activate a first wordline of a first block of the memory blocks and a second wordline of a second block of the memory blocks, wherein the first and second blocks correspond to a same plane of the memory device; and
following activation of the first and second wordlines, sequentially stagger activation of a first bitline corresponding to the first block and activation of a second bitline corresponding to the second block.

2. The memory system of claim 1, wherein the controller is configured to sense data from the first block concurrently with activation of the second bitline.

3. The memory system of claim 2, wherein the controller is configured to sense data from the second block subsequent to sensing the data from the first block.

4. The memory system of claim 1, wherein the controller is configured to write super pages in a ping-pong manner between first and second super blocks to form a virtual super block, wherein the first and second blocks are included in the first and second super blocks, respectively.

5. The memory system of claim 1, wherein the first and second blocks comprise logically conjugate block pairs within the same plane.

6. The memory system of claim 5, wherein the controller is configured to select the logically conjugate block pairs by masking a least significant bit of corresponding block addresses.

7. The memory system of claim 1, wherein the controller is configured to:
sense data from the first block while activating the second bitline; and
sense data from the second block after completing sensing of the data from the first block.

8. The memory system of claim 1, wherein the controller is configured to:
construct virtual super blocks by selecting logically consecutive super blocks, wherein the first and second blocks are included in different super blocks of a virtual super block, and the virtual super block is confined to a high read bandwidth partition of the memory device.

9. A method, comprising:
providing a virtual super block of memory, the virtual super block comprising first and second super blocks, wherein each of the first and second super blocks comprises respective blocks of memory cells from respective planes of multiple memory dies;
concurrently activating a first wordline of a first block of the first super block and a second wordline of a second block of the second super block of the virtual super block;
following activation of the wordlines, activating a first bitline of the first block; and
following activation of the first bitline, sensing data from the first bitline of the first block and activating a second bitline of the second block.

10. The method of claim 9, further comprising writing data in an alternating manner between super pages of the first and second super blocks of the virtual super block.

11. The method of claim 9, wherein providing the virtual super block includes using the first and second super blocks with logically conjugate block addresses.

12. The method of claim 9, wherein the activation of the second bitline occurs concurrently with the sensing data from the first bitline.

13. The method of claim 12, wherein the sensing of the data in the first block and the data in the second block includes using a same page buffer in line with both the first block and the second block.

14. The method of claim 9, wherein the first block and the second block comprise portions of a same plane of the virtual super block.

15. The method of claim 9, further comprising selecting the first block and the second block based on the first and second blocks being in a same logical position of the respective first super block and the respective second super block.

16. The method of claim 9, comprising writing super pages in a ping-pong manner between the first and second super blocks of the virtual super block, wherein the ping-pong writing enables concurrent reads on the first and second super blocks using the same page address within a particular plane.

17. The method of claim 9, further comprising selecting the first block and the second block such that the first block and the second block are accessed using a same page address.

18. A memory system comprising:
a non-volatile memory device including a plurality of memory blocks; and
a controller configured to:
write information to a virtual super block comprising a first super block and a second super block, wherein the first super block and the second super block each include memory blocks from multiple planes of the non-volatile memory device, wherein writing the information includes:
identifying a first conjugate block pair from a particular plane of a particular die of the memory device, the first conjugate block pair including a first memory block and a second memory block that is logically adjacent to the first memory block;
concurrently activating a wordline for the first and second memory blocks of the first conjugate block pair; and
while the wordlines are activated for the first and second memory blocks, writing a first portion of the information to the first memory block and subsequently writing a second portion of the information to the second memory block.

19. The memory system of claim 18, wherein writing the information includes:
writing first super pages to the first memory block of the first super block; and
writing second super pages to the second memory block of the second super block in an alternating manner with the writing of the first super pages.

20. The memory system of claim 19, wherein the controller is configured to access data from the first and second super blocks using a same page address.
